(19) United States
(12) Patent Application Publication
(10) Pub. No.: US 2018/0039301 A1
(43) Pub. Date: Feb. 8, 2018

(54) Video Recording System Based on Device Orientation

(71) Applicant: Sasha Gelbart, Malibu, CA (US)

(72) Inventor: Sasha Gelbart, Malibu, CA (US)

(21) Appl. No.: 15/672,269

(22) Filed: Aug. 8, 2017

Related U.S. Application Data
(60) Provisional application No. 62/372,042, filed on Aug. 8, 2016.

(51) Int. Cl. G06F 1/16; G01P 15/08

(52) U.S. Cl. CPC G06F 1/1626; G01P 15/08; G06F 2200/1614; G06F 2200/1637

(57) ABSTRACT

A video recording system includes: a controller that receives an output from the accelerometer to recognize the orientation of the display; and in response to the display being recognized as being in a first landscape position, executing a capture-ready mode in which the controller receives video from the video-capture sensor to be stored as one of the one or more video files; in response to the display being recognized as being in a second landscape position, executing a playback mode in which the controller causes one of the one or more video files to play on the display; in response to the display being recognized as being in portrait positon, executing an edit mode in which the controller responds to input received through the one or more input mechanisms to edit one of the one or more video files.

### CROSS-REFERENCE TO RELATED APPLICATION

This application claims the benefit of priority to U.S. Provisional Application No. 62/372,042 filed on Aug. 8, 2016, the entirety of which is incorporated herein by reference.

### BACKGROUND OF THE INVENTION

The present subject matter relates generally to a video recording system. More specifically, the present invention relates to a video recording system that allows for specific functionalities to be provided based on the orientation of the mobile device.

The vast majority of smart phones are equipped with video capture technology, providing users with the ability to record videos. Video capabilities are used to capture life events ranging from the routine children's ballet class to significant life events such as graduations and weddings. Camera technology in smart phones has advanced to such a degree that it has virtually replaced standalone cameras in all but the most professional of settings.

To advance from a locked device to recording videos on a smart phone or similar mobile device, a user typically must engage with a series of on-screen user interface elements. For example, the user must first unlock the device with a passcode or fingerprint. The user must then identify and select the video recording application. The user must then choose the right camera mode and initiate the recording, etc. All of these steps can delay recording readiness, which can be the difference between catching the right moment or missing it entirely. Although some hardware manufacturers have built dedicated “shutter-release” buttons into their handsets (or allow users to assign that functionality to the volume rockers), those buttons tend to work like “quick launchers” for the supported video capture application. These “quick launch” applications still require at least another extra step of pressing a record button to start recording. It would be beneficial for users to have easier and quicker access to recording functionality.

Another problem with the prior systems and methods, is there typically is not an easily implemented control for enforcing a “landscape-only” recording aspect ratio, which provides superior video formatting for later viewing on other devices. It is believed that simply requiring video recording to take place in a landscape aspect ratio would improve user experience and the quality of the recorded end product.

Accordingly, there is a need for a video recording system which allows recording to be activated and deactivated in a more efficient manner.

### BRIEF SUMMARY OF THE INVENTION

In one embodiment of the video recording system, the system dedicates modes of functionality to distinct mobile device orientations measured by the device's onboard accelerometer, so that all modes are instantly available based upon the device's orientation. Specifically, the system includes a user's mobile device with an accelerometer and a video-capture sensor. The user's mobile device also includes a memory and a processor in communication with the memory that is programmed with instructions that, when executed, control the transition between the modes of functionality triggered by gyroscopic data from the accelerometer. The software monitors accelerometer data to respond to defined orientations of the device, including landscape-left, portrait, and landscape-right, to initiate the three distinct video-related modes of functionality, including capture, editing, and playback modes, respectively.

In one embodiment, positioning the mobile device with the display screen in the portrait (home) position triggers the processor to provide a user interface that includes functionality that enables the user to edit a video in edit mode. Rotation of the mobile device counterclockwise into the “landscape-left” position initiates a “capture-ready” mode, triggering the processor to provide a user interface that includes functionality that enables the user to record a video. Additionally, rotation of the device clockwise from the home position into the “landscape-right” position initiates a full-screen playback mode of the current video project selected on the home screen, triggering the processor to provide a user interface with functionality to play back the current video. The above example assumes a right-handed user; however, the clockwise and counterclockwise orientation states are reversible and interchangeable as needed or desired to account for factors like the handedness of a user.

A goal of the present invention is to create an easy and fast interface for the capture, editing, and playback of video content.

An advantage of the present invention is instant access to video capture, editing, and playback modes regardless of current activity on the system's software. This means a user can quickly switch from editing or viewing a first video to recording a second video with the turn of a wrist, eliminating the need to select an option or press a button to switch modes.

Another advantage of the present invention is that, given that a landscape orientation activates recording, the capture of video is restricted to a landscape-only orientation. By restricting capture mode to a landscape orientation, the resulting video files are uniformly in a landscape orientation, the preferred video orientation for the vast majority of users. This uniformity also makes editing videos together easier since they are all formatted the same with the same orientation.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of an example embodiment of the elements of a video recording system.

FIGS. 2A-2C illustrate front elevational views of the mobile device in the portrait position, the landscape-left position, and the landscape-right position, respectively.

FIG. 3 is a flow chart illustrating the steps of a method of transitioning modes of functionality of the video recording system of FIG. 1.

FIGS. 4A-4D are front elevational views of edit mode user interfaces of the video recording system of FIG. 1.

FIGS. 5A and 5B are front elevational views of capture mode user interfaces of the video recording system of FIG. 1.

FIG. 6 is a front elevational view of a playback mode user interface of the video recording system of FIG. 1.

### DETAILED DESCRIPTION OF THE INVENTION

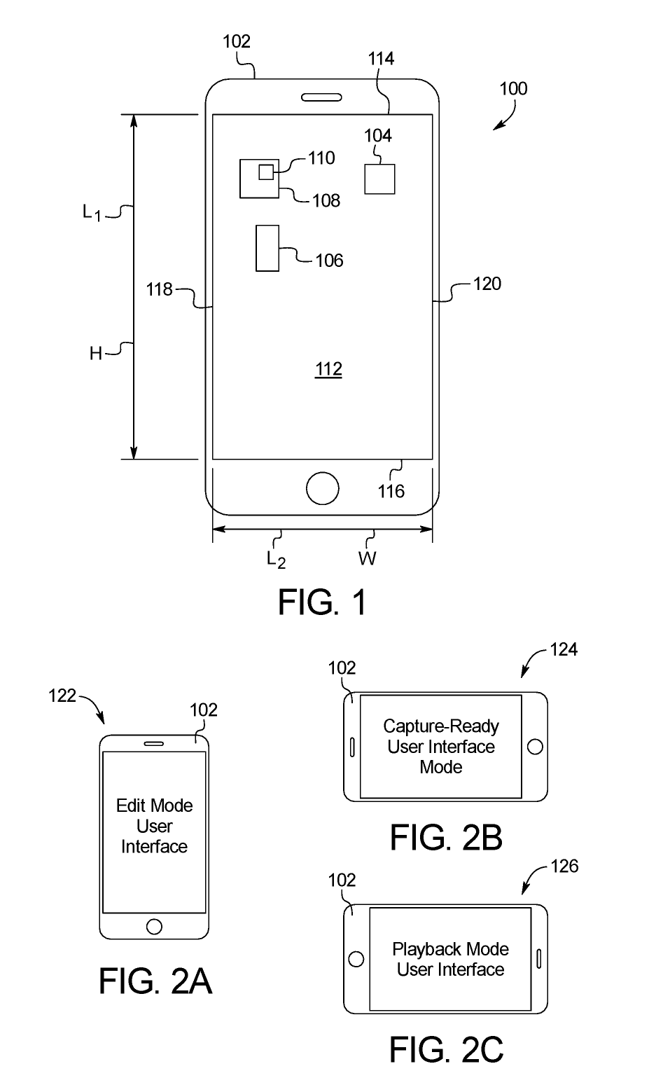

FIG. 1 illustrates an example of a video recording system 100 based on device orientation. As shown in FIG. 1, the video recording system 100 includes a mobile device 102 having an accelerometer 104 and a video-capture sensor 106. A controller 108 on the mobile device 102 is in communication with a memory 110 that is programmed with instructions to, when executed, receive an output from the accelerometer 104 and provide a user interface associated with the output. The controller 108 is also in communication with the accelerometer 104 and the video-capture sensor 106. The memory 110 includes one or more video files stored on the mobile device 102. In one embodiment, the video-capture sensor is in communication with a camera that captures the image being recorded. The video-capture sensor then converts the recording to a digital format.

The mobile device 102 includes a display 112 having a height H defined by a first line L₁ spanning from a top 114 of the display to a bottom 116 of the display 112 that is greater than a width W defined by a second line L₂ spanning from a left side 118 of the display to a right side 120 of the display in a portrait or neutral position. In one embodiment, the gyroscopic data is associated with one of the three orientations of the mobile device: the portrait position 122 shown in FIG. 2A, the landscape-left position 124 shown in FIG. 2B, and the landscape-right position 126 shown in FIG. 2C. Specifically, the landscape-left position 124 is defined when the display 112 is rotated counter-clockwise 90 degrees from the portrait position 122, and the landscape-right positon 126 is defined when the display 112 is rotated clockwise 90 degrees from the portrait position 122.

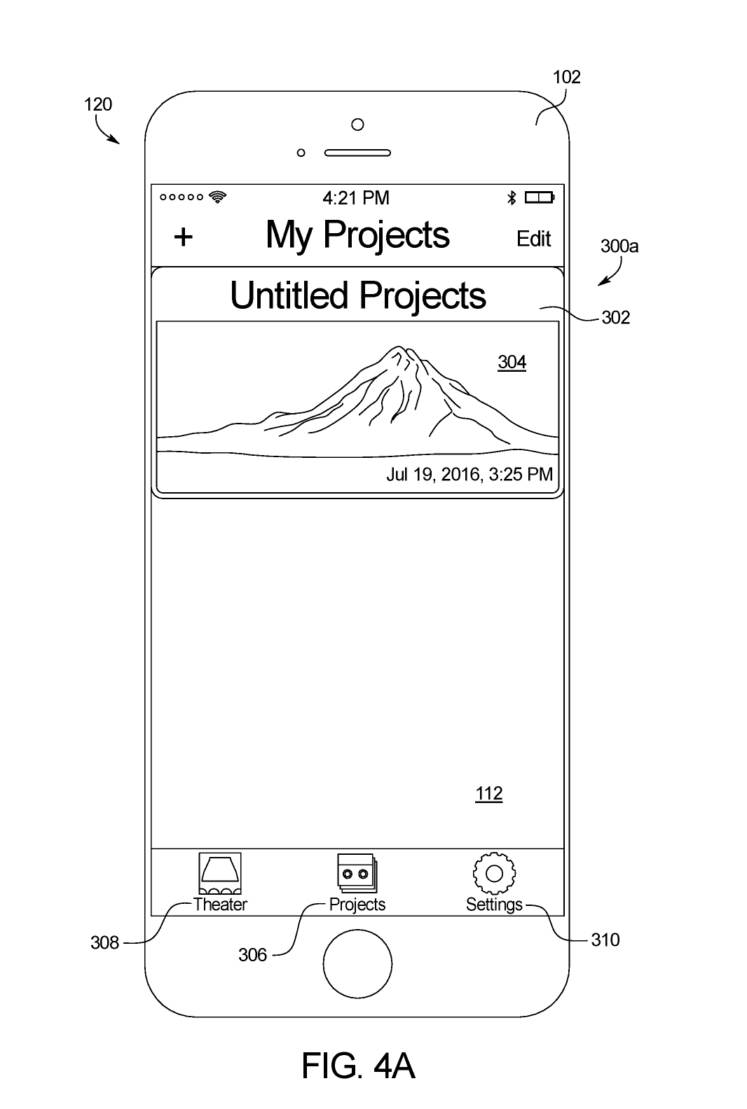

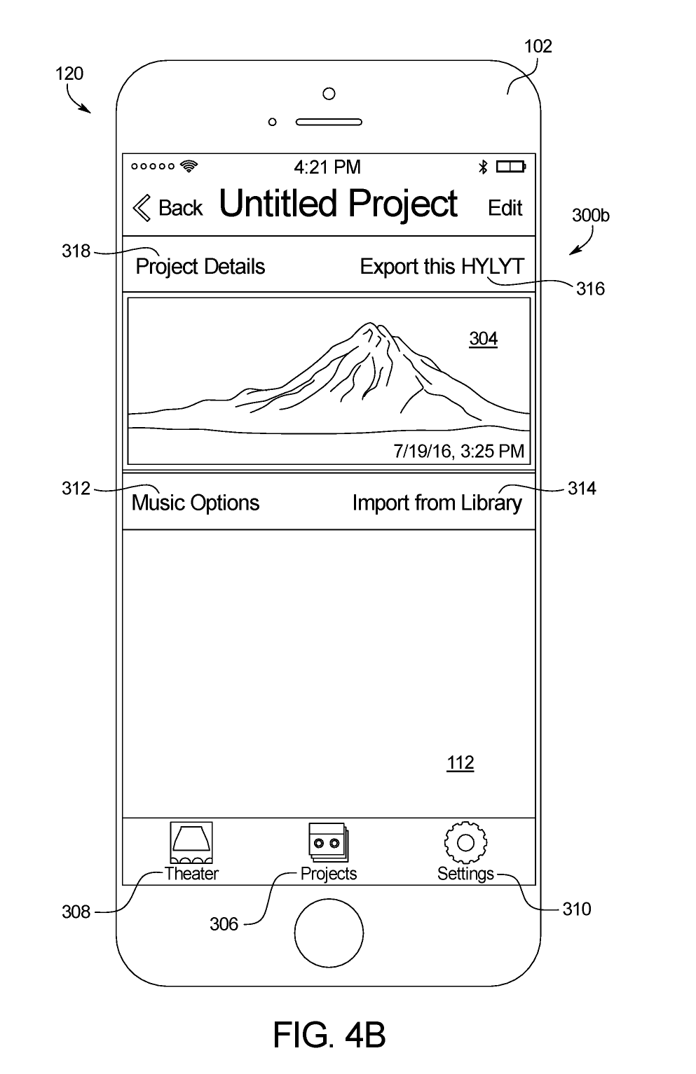

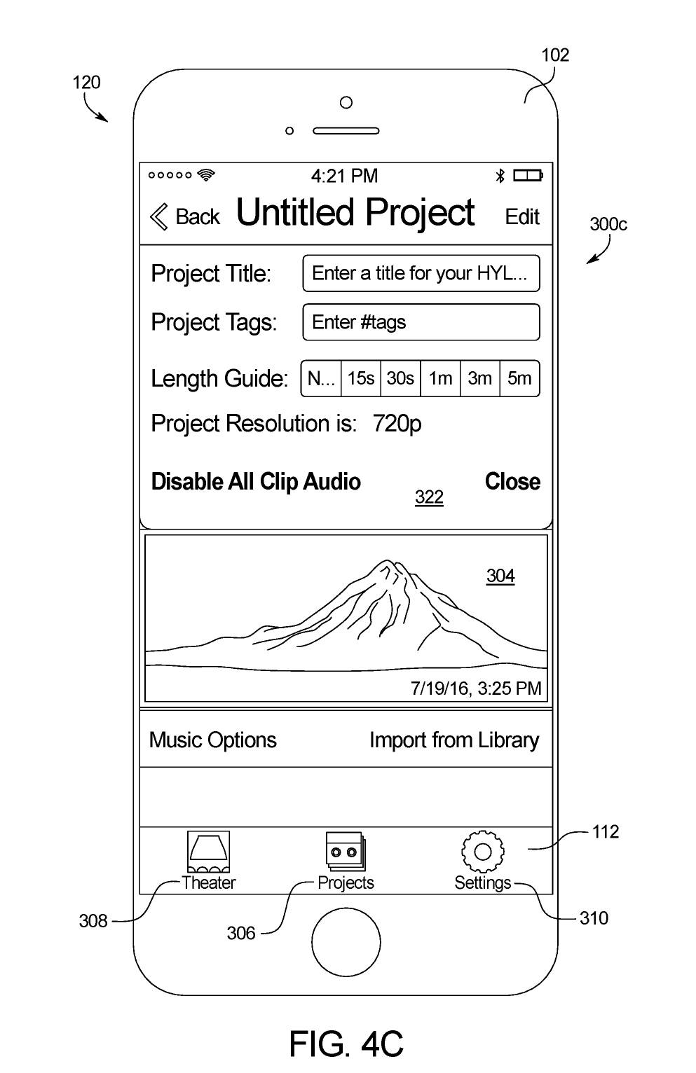

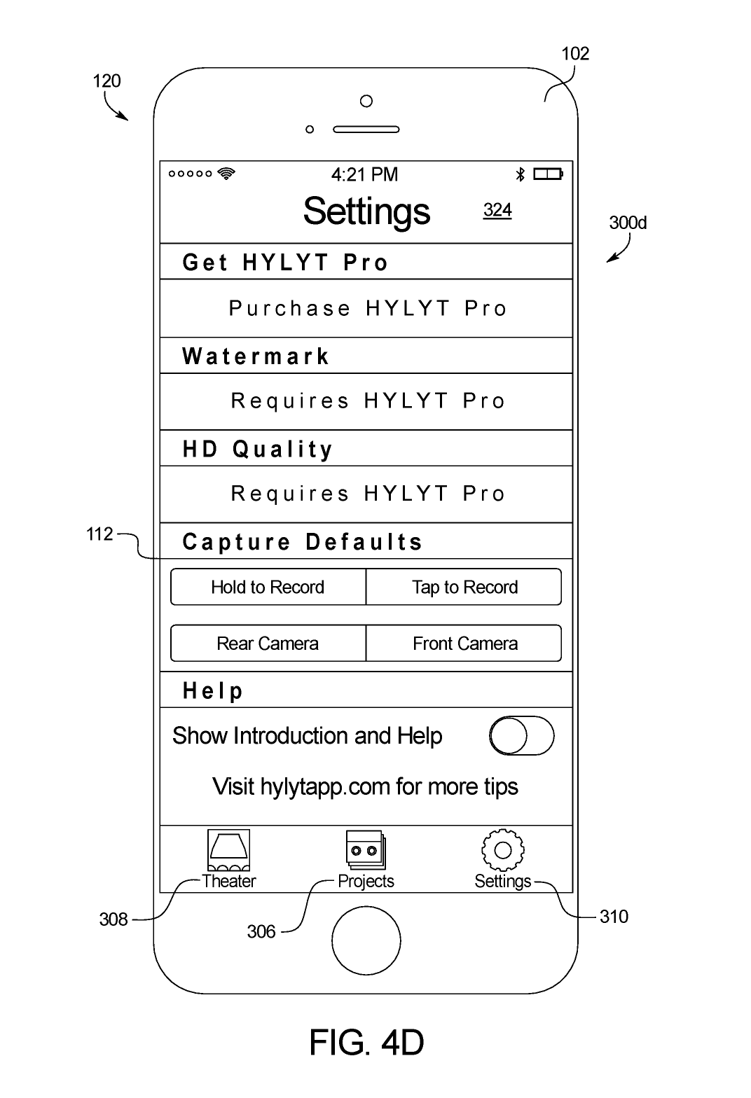

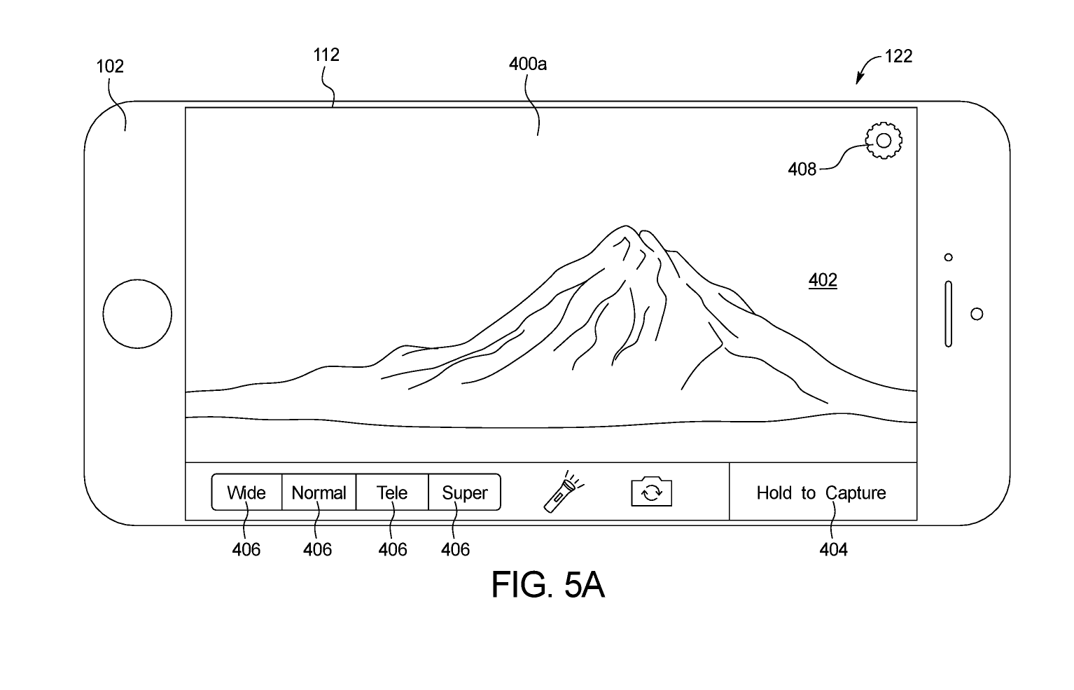

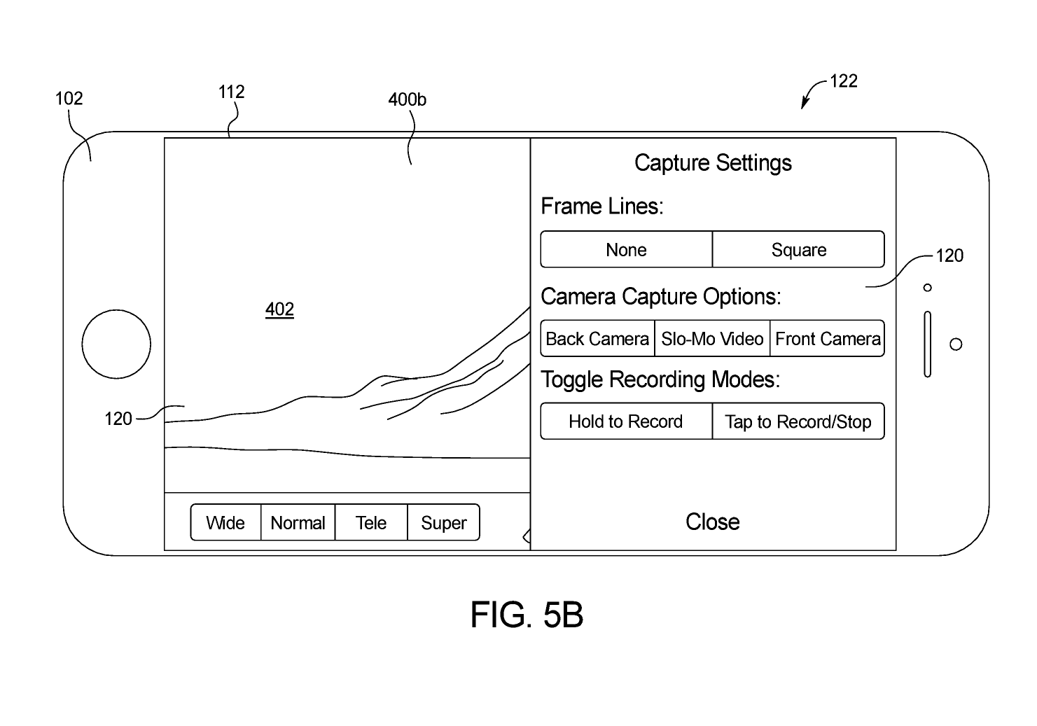

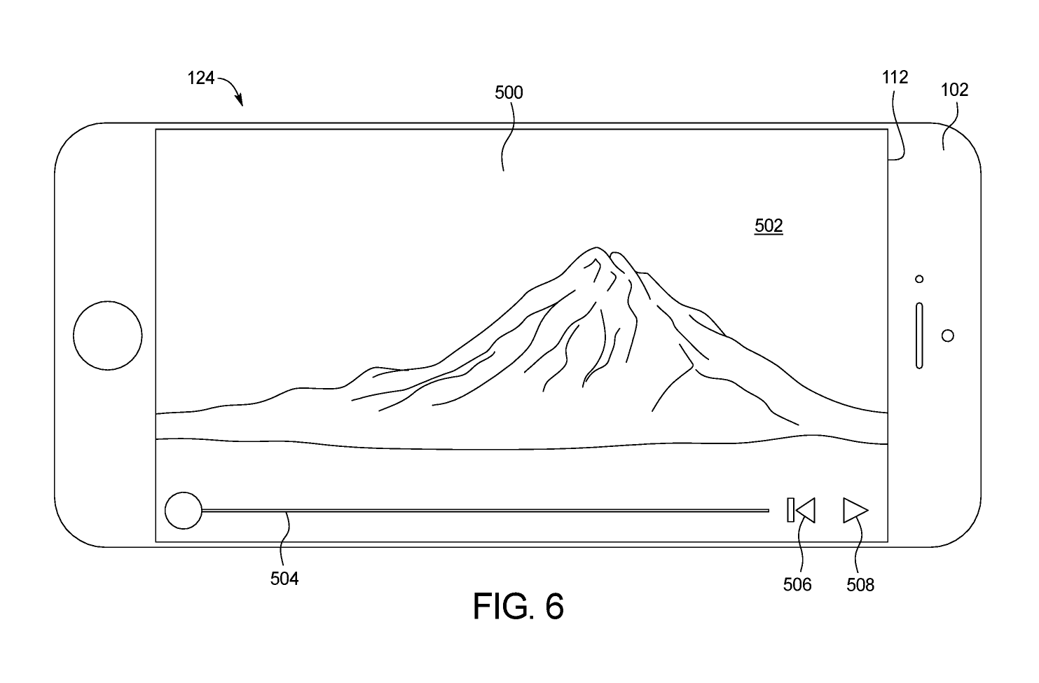

Each orientation 120-124 is associated with one of three functionalities of user interfaces: an edit mode user interface 126 shown in FIGS. 4A-4D, a capture-ready mode user interface 128 shown in FIGS. 5A and 5B, and a playback mode user interface 130 shown in FIG. 6. The controller 108 is in communication with the display 112 so that the controller 108 may execute one of the three functionalities of user interfaces in response to receipt of an output from the accelerometer 104.

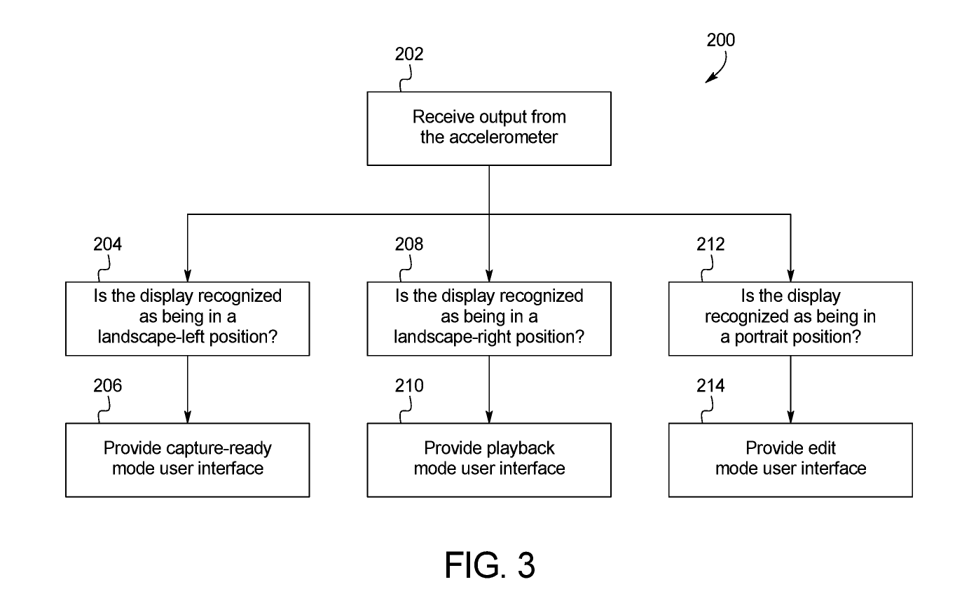

Turning now to FIG. 3, a method 200 of transitioning modes of functionality triggered by output from the accelerometer 104 is provided. The first step 202 of the method 200 is receiving an output from the accelerometer 104 on the mobile device 102 to recognize the orientation of the display 112. In the illustrated example, the output is gyroscopic data that indicates in which position the mobile device 102 is oriented. For example, the gyroscopic data may indicate whether the mobile device 102 is held in the portrait position 122, the landscape-left position 124, or the landscape-right position 126.

In response to the display being recognized as being in landscape-left position 124 in step 204, the controller executes a capture-ready mode in which the controller receives video from the video-capture sensor to be stored as one of the one or more video files in step 206. In this step, the output from the accelerometer may include gyroscopic data indicating that the mobile device is held in the landscape-left position 124, prompting the controller to provide the edit mode user interface on the display screen of the mobile device.

In response to the display being recognized as being in landscape-right position 126 in step 208, the controller executes a playback mode in which the controller causes one of the one or more video files to play on the display in step 210. In this step, the output from the accelerometer may include gyroscopic data indicating that the mobile device is held in the landscape-right position 126, prompting the controller to provide the playback mode user interface on the display screen of the mobile device.

In response to the display being recognized as being in portrait position 122 in step 212, the controller executes an edit mode in which the controller responds to input received through the one or more input mechanisms to edit one of the one or more video files in step 214. In this step, the output from the accelerometer may include gyroscopic data indicating that the mobile device is held in the portrait position 122, prompting the controller to provide the edit mode user interface on the display screen of the mobile device.

FIGS. 4A-4D illustrate edit mode user interfaces 300a-300d of the mobile device application when the mobile device 102 is held in the portrait position 122. In the first edit mode user interface 300a shown in FIG. 4A, a recording library 302 including one or more video recordings 304 to be edited is provided. The recording library 302 may be accessed at any time upon selection of the projects button 306 at the bottom of the display 112. To edit a video recording 304, the user selects a video recording 304 from the recording library 302, which leads to further edit mode user interfaces that provide user selections for specific aspects of the video editing. Each edit mode user interface 300a-300d includes three touchscreen buttons along the bottom of the display 112 which allow access to a theater mode button 308, the projects button 306, and a settings button 310.

After a video recording 304 has been selected for editing, the video recording 304 may be edited in various ways by selecting user input mechanisms as shown in a second edit mode user interface 300b shown in FIG. 4B. The user may modify music for the video by selecting a music options button 312, may import data by selecting an import button 314, or may export the video by selecting an export button 316. The user may also select the project details button 318, which leads to a third edit mode user interface shown in FIG. 4C.

FIG. 4C illustrates the editing of the details 320 of a video recording 304 in a third edit mode user interface 300c. When a user opts to edit the details 320 of a video recording 304, a menu 322 is displayed, allowing the user to adjust video recording details 320 such as resolution, the recording name, tags for the recording, recording length (e.g., play time of the edited video), and audio settings.

FIG. 4D is a fourth edit mode user interface 300d of the mobile device application including a settings menu 324 provided upon the selection of the settings button 310. The settings menu 324 allows the user to modify video recording settings, playback settings, water mark settings, etc.

FIGS. 5A and 5B illustrate capture mode user interfaces 400a, 400b when the mobile device 102 is held in the left-landscape orientation 122. As shown in FIG. 5A, the mobile device 102 will display the initial capture-ready mode user interface 400a featuring a video recording screen 402 as shown in FIG. 5A. The video recording screen 402 presents the image captured by the video capture sensor and allows the user to record the video. Recording may be initiated by selecting or tapping the record button 404. Via the application settings shown in FIG. 5B, the user can toggle the recording mode to initiate recording by holding the record button 404 or by simply rotating the mobile device into the landscape-left position 124. Recording may be stopped in a similar fashion, such as tapping the button 404 again, releasing the button 404 if being held, or changing the orientation of the device 102 from the landscape-left position 124. The capture-ready mode user interface 400a also includes buttons 406 to change settings of the recording and a settings button 408, the selection of which leads to the second capture-ready mode user interface 400b.

As shown in FIG. 5B, the second capture-ready mode user interface 400b provides the recording settings menu 410 prompted by selecting the settings button 408. The user may modify certain aspects of the recording via the recording settings menu 410, such as the type of frame lines, the camera options, and the recording mode, among other possible settings. The user can also turn the flash on and off when recording and alter the aspect ratio with which they are recording. Other optional settings may be added as desired.

FIG. 6 illustrates a playback mode user interface 500 when the mobile device 102 is held in the landscape-right position 126. The mobile device 102 will display the most recent video recording 304 from the library 302 on a playback screen 502 of the playback mode user interface 500. The user may also select another recording 304 from the video recording library 302 shown in FIG. 3A and then rotate the mobile device 102 to the landscape-right position 126 in order to play the video. The playback screen 502 may feature a touch responsive play bar 504, a video restart button 506, and a play button 508.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A video recording system comprising:
a video-capture sensor;
a display having height defined by a first line spanning from a top of the display to a bottom of the display that is greater than a width defined by a second line spanning from a left of the display to a right of the display, wherein portrait position is defined as a neutral position, landscape-left position is defined when the display is rotated counter-clockwise 90 degrees from the neutral position and landscape-right positon is defined when the display is rotated clockwise 90 degrees from the neutral position;
an accelerometer;
one or more input mechanisms;
a controller in communication with the video-capture sensor, the display, the one or more input mechanisms, and the accelerometer; and
a memory in communication with the controller, the memory including one or more video files, the memory further including program instructions executable by the controller that, when executed by the controller, cause the controller to:
receive an output from the accelerometer to recognize the orientation of the display;
in response to the display being recognized as being in landscape-left position, execute a capture-ready mode in which the controller receives video from the video-capture sensor to be stored as one of the one or more video files;
within capture-ready mode, provide one or more input mechanisms to start and stop recording of the video file;
in response to the display being recognized as being in landscape-right position, execute a playback mode in which the controller causes one of the one or more video files to play on the display;
within playback mode, provide one or more input mechanisms to start and stop playing of the video file;
in response to the display being recognized as being in portrait positon, execute an edit mode in which the controller responds to input received through the one or more input mechanisms to edit one of the one or more video files;
within edit mode, provide one or more input mechanisms for adjusting the resolution of the video file, adding music to the video file, and selecting a length of time a duration of the video file; and
within edit mode, provide one or more input mechanisms for accessing a video library listing the one or more video files and a settings menu.

2. The video recording system of claim 1, wherein the output from the accelerometer is gyroscopic data.

3. A video recording system comprising:
a video-capture sensor;
a display having height defined by a first line spanning from a top of the display to a bottom of the display that is greater than a width defined by a second line spanning from a left of the display to a right of the display, wherein portrait position is defined as a neutral position, landscape-left position is defined when the display is rotated counter-clockwise 90 degrees and landscape-right positon is defined when the display is rotated clockwise 90 degrees, wherein landscape-left position and landscape right position are collectively are the landscape positions;
an accelerometer;
one or more input mechanisms;
a controller in communication with the video-capture sensor, the display, the one or more input mechanisms, and the accelerometer; and
a memory in communication with the controller, the memory including one or more video files, the memory further including program instructions executable by the controller that, when executed by the controller, cause the controller to:
receive an output from the accelerometer to recognize the orientation of the display; and
in response to the display being recognized as being in a first landscape position, executing a capture-ready mode in which the controller receives video from the video-capture sensor to be stored as one of the one or more video files;
in response to the display being recognized as being in a second landscape position, executing a playback mode in which the controller causes one of the one or more video files to play on the display;
in response to the display being recognized as being in portrait positon, executing an edit mode in which the controller responds to input received through the one or more input mechanisms to edit one of the one or more video files.

4. The video recording system of claim 3, wherein the first landscape position is landscape-left position and the second landscape position is landscape-right position.

5. The video recording system of claim 3, wherein the first landscape positon is landscape-right position and the second landscape position is landscape-left position.

6. The video recording system of claim 3, wherein the memory further includes program instructions executable by the controller that, when executed by the controller, cause the controller to:
within capture-ready mode, provide one or more input mechanisms to start and stop recording of the video file.

7. The video recording system of claim 3, wherein the memory further includes program instructions executable by the controller that, when executed by the controller, cause the controller to:
within playback mode, provide one or more input mechanisms to start and stop playing of the video file.

8. The video recording system of claim 3, wherein the memory further includes program instructions executable by the controller that, when executed by the controller, cause the controller to:
within edit mode, provide one or more input mechanisms for adjusting the resolution of the video file, adding music to the video file, and selecting a length of time a duration of the video file.

9. The video recording system of claim 3, wherein the memory further includes program instructions executable by the controller that, when executed by the controller, cause the controller to:
within edit mode, provide one or more input mechanisms for accessing a video library listing the one or more video files and a settings menu.

10. A method of recording and editing a video file comprising the steps of:
providing a mobile device comprising:
a video-capture sensor;
a display having height defined by a first line spanning from a top of the display to a bottom of the display that is greater than a width defined by a second line spanning from a left of the display to a right of the display, wherein portrait position is defined as a neutral position, landscape-left position is defined when the display is rotated counter-clockwise 90 degrees from the neutral position and landscape-right positon is defined when the display is rotated clockwise 90 degrees from the neutral position, and wherein landscape-left position and landscape right position are collectively are the landscape positions;
an accelerometer;
one or more input mechanisms;
receiving an output from the accelerometer to recognize the orientation of the display;
in response to the display being recognized as being in a first landscape position, executing a capture-ready mode in which the controller receives video from the video-capture sensor to be stored as one of the one or more video files;
in response to the display being recognized as being in a second landscape position, executing a playback mode in which the controller causes one of the one or more video files to play on the display; and
in response to the display being recognized as being in portrait positon, executing an edit mode in which the controller responds to input received through the one or more input mechanisms to edit one of the one or more video files.
